(19) United States
(12) Patent Application Publication
(10) Pub. No.: US 2009/0025588 A1
(43) Pub. Date: Jan. 29, 2009

(54) Imprint apparatus and imprint method using the same

(75) Inventors: Dae-jin Park, Incheon (KR); Jang-kyum Kim, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/156,773

(22) Filed: Jun. 3, 2008

(30) Foreign Application Priority Data
Jul. 26, 2007 (KR) 10-2007-0075310

(51) Int. Cl. B41F 1/00

(52) U.S. Cl. 101/287

(57) ABSTRACT

The present invention relates to an imprint apparatus for forming a transfer pattern on a substrate. The imprint apparatus includes a container comprising a pattern forming material and a mold member comprising an imprint pattern formed on a surface.

### CROSS-REFERENCE TO RELATED APPLICATION

This application claims priority from Korean Patent Application No. 10-2007-0075310, filed on Jul. 26, 2007 in the Korean Intellectual Property Office, the disclosure of which is incorporated herein by reference.

### BACKGROUND OF THE INVENTION

(a) Field of the Invention

The present invention relates to an imprint apparatus and an imprint method using the same.

(b) Description of the Related Art

A performance of a flat panel display device such as a liquid crystal display is rapidly improving with a rapidly developing semiconductor technology.

An image of the flat panel display device is displayed by a plurality of pixels formed with active switching devices such as thin film transistors. The size of one pixel is generally several tens of microns and many processes for forming a fine pattern are required to form each pixel. Accordingly, a patterning technology of forming the fine pattern takes an important position in manufacturing the flat panel display device.

Recently, a method of forming a pattern using an imprint apparatus (hereinafter, “imprint method”) has been developed and is under use. The imprint method refers to a pattern forming method using a mold formed with an imprint pattern. That is, the imprint method is forming a transfer pattern on the substrate through joining the mold having the imprint pattern with a substrate while a pattern forming material is disposed between the mold and the substrate.

However, the imprint method has a problem of deteriorating a product quality due to a trapped air and the formation of a gas bubble produced during joining of the mold and the substrate.

### SUMMARY OF THE INVENTION

An aspect according to the present invention provides an imprint apparatus of forming a transfer pattern on a substrate, including a container including a pattern forming material, and a mold member including an imprint pattern formed on a surface.

The pattern forming material may include a liquid phase resin.

The substrate may be immersed in the pattern forming material and the imprint pattern formed on the surface of the mold member may be contact with the substrate.

The imprint apparatus may include a substrate supporting part supporting the substrate, a mold supporting part supporting the mold member, a substrate moving part moving the substrate supporting part to immerse the substrate into the pattern forming material, and a mold moving part moving the mold supporting part to selectively move the mold member into contact with the substrate.

The substrate may be detachably supported on substrate supporting part by a vacuum adsorption method.

The mold member is may detachably supported on the mold supporting part by a vacuum adsorption method.

The substrate moving part and the mold moving part may respectively move the substrate supporting part and the mold supporting part in an upward and downward direction.

The mold moving part may move the mold supporting part within a range that the mold supporting part is partially immersed or not immersed into the pattern forming material.

At least one of the substrate supporting part and the substrate moving part may shake the substrate in the pattern forming material.

At least one of the mold supporting part and the mold moving part may shake the mold member immersed in the pattern forming material.

Another aspect according to the present invention provides an imprint method of forming a transfer pattern on a substrate, including providing a bath comprising a pattern forming material, immersing the substrate in the pattern forming material, and joining the substrate with a mold member having an imprint pattern in the pattern forming material.

The pattern forming material may include a liquid phase resin.

The substrate may be detachably supported by a substrate supporting part and the substrate supporting part is moved by a substrate moving part to immerse the substrate in the pattern forming material.

The mold member may be detachably supported by a mold supporting part and the mold supporting part may be moved by a mold moving part to join the mold member and the substrate in the pattern forming material.

The mold supporting part may not be immersed or partially immersed in the pattern forming material.

The imprint method may include taking out the substrate joined with the mold member from the pattern forming material.

The imprint method may include shaking at least one of the substrate and the mold member before the joining of the substrate with the mold member.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a schematic view of an imprint apparatus according to an exemplary embodiment of the present invention;

FIG. 2 is an enlarged view of a portion of a mold member of the imprint apparatus in FIG. 1;

FIGS. 3, 4, 6, and 7 are schematic views illustrating an imprint method according to an exemplary embodiment of the present invention in a sequential order;

FIG. 5 is an enlarged view of a portion of the contacted substrate and mold member in the pattern forming material according to an exemplary embodiment of the present invention; and

FIG. 8 is an enlarged view a portion the substrate on which a transfer pattern is formed according to the present invention.

### DETAILED DESCRIPTION OF THE EMBODIMENTS

Hereinafter, exemplary embodiments of the present invention are described in detail referring to appended figures to be easily embodied by those of common knowledge related to the technical field of the present invention. The present invention may be embodied with different forms in a variety of ways and is not restricted to the exemplary embodiments of this description.

The same reference character is assigned for the same or similar elements throughout the detailed description for the clarity in description of the present invention.

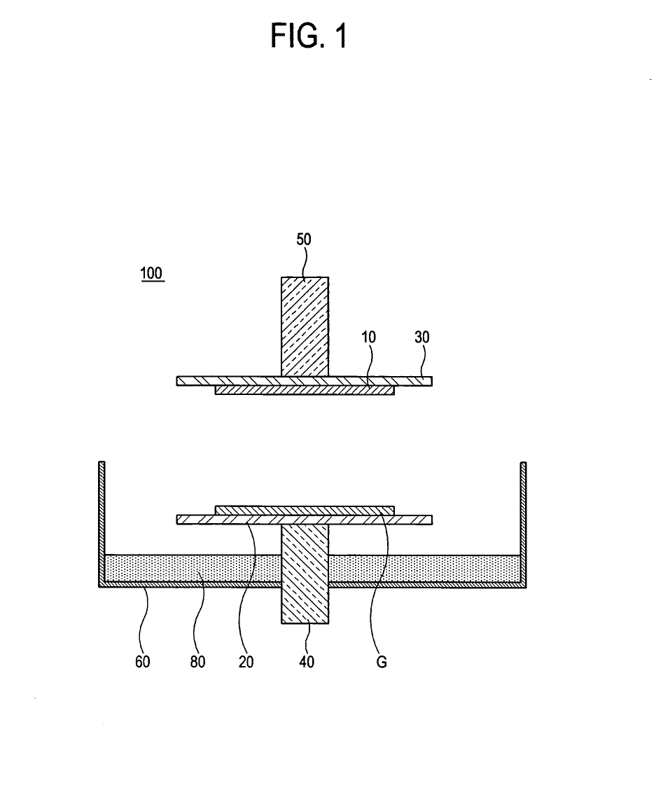

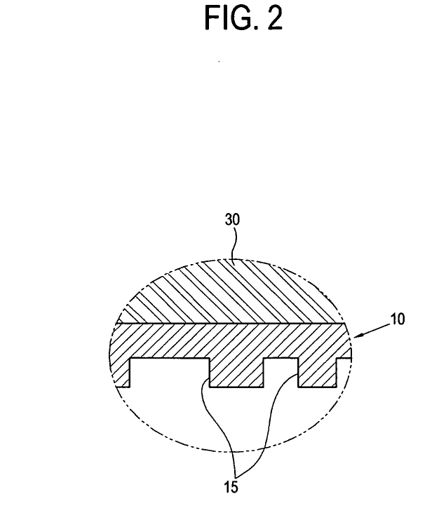

An imprint apparatus 100 according to an exemplary embodiment of the present invention is described below referring to FIGS. 1 and 2.

FIG. 1 is a schematic view of an imprint apparatus according to an exemplary embodiment of the present invention, and FIG. 2 is an enlarged view of a portion of a mold member of the imprint apparatus in FIG. 1.

As shown in FIGS. 1 and 2, the imprint apparatus 100 includes a mold member 10 with an imprint pattern 15 and a bath 60 containing a pattern forming material 80. Further, the imprint apparatus 100 includes a substrate supporting part 20, a mold supporting part 30, a substrate moving part 40, and a mold moving part 50. Referring to FIG. 2, the imprint pattern 15 includes an embossed surface.

The pattern forming material 80 is a liquid phase resin. Known resins in a variety of kinds may be used for the pattern forming materials 80. For example, thermoplastic resins, thermosetting resins and photo curable resins may be used for the pattern forming material 80 according to a method of pattern forming process.

The photo curable resins may include urethane resin, epoxy resin and acrylic resin and the like. Specifically, the photo curable resins may include low viscous UV (Ultraviolet) curable resins like HDDA (1,6-hexanediol-diacrylate), HEBDM (bis(hydroxyethly)bisphenol-A dimethacrylate) and the like.

Thermosetting resins may include phenol resins, epoxy resins, silicon resins, polyimide and the like.

Thermoplastic resins may include polymethylmethacrylate (PMMA), polycarbonate (PC), polyethyleneterephthalate (PET), acrylic resins and the like.

The mold member 10 is placed in contact with a substrate G while immersed into the pattern forming material 80 contained in the bath 60.

That is, the mold member 10 is placed into contact with the substrate G in the pattern forming material 80 by operating of mold moving part 50.

At this time, the pattern forming material 80 flowed into spaces formed between the embossed surface of the imprint pattern 15 and the substrate G x is cured or solidified to form the transfer pattern on the substrate G.

The mold member 10 may be made of various materials. In particular, the mold member 10 may be made of, for example, a silicon elastomer such as polydimethylsiloxane (PDMS).

The imprint pattern 15 having the embossed surface is formed on one surface of the mold member 10, which is contacted with the substrate G.

The substrate supporting part 20 supports the substrate G. The substrate supporting part 20 detachably supports the substrate G by, for example, a vacuum adsorption method. Here, the vacuum adsorption method may be performed using well-known vacuum adsorption facility.

The mold supporting part 30 supports the mold member 10 with the imprint pattern 15. The mold supporting part 30 also detachably supports the mold member 10 using the vacuum adsorption method. In other words, the mold supporting part 30 supports the mold member 10 by using vacuum pressure.

However, the supporting method of the substrate supporting part 20 and the mold supporting part 30 is not limited to the vacuum adsorption method. Thereby, the substrate supporting part 20 and the mold supporting part 30 may support the substrate G and the mold member 10 by using known various other methods.

The substrate moving part 40 moves the substrate supporting part 20 to immerse the substrate G in the pattern forming material 80. The substrate moving part 40 moves the substrate supporting part 20 in an upward and downward direction.

Also, the substrate moving part 40 moves the substrate supporting part 20 slowly in order not to produce bubbles in a process of immersing the substrate G into the pattern forming material 80. That is, to restrict a production of the bubbles that could result in an inferior transfer pattern formed on the substrate G. Here, a speed that the substrate moving part 40 moves the substrate supporting part 20 may be properly adjusted according to a kind and a property of the pattern forming material 80 within a range of not producing any bubbles when the substrate G is immersing.

Also, at least one of the substrate supporting part 20 and the substrate moving part 40 may shake the substrate G in the pattern forming material 80. In other words, at least one of the substrate supporting part 20 and the substrate moving part 40 may shake left and right or vibrates the substrate G in the pattern forming material 80. Accordingly, bubbles that may remain on the substrate G immersed in the pattern forming material 80 can be removed.

The mold moving part 50 moves the mold supporting part 30 such that mold member 10 contacts substrate G while it is immersed in the pattern forming material 80. In other words, the mold moving part 50 contacts the mold member 10 with the substrate G immersed in the pattern forming material 80. The mold supporting part 30 may be separated from the mold member 10 while it is in contact with the substrate G. the mold moving part 50 moves the mold supporting part 30 in the upward and downward direction.

Further, the mold moving part 50 moves the mold supporting part 30 slowly in order not to produce bubbles in a process of immersing the mold member 10 into the pattern forming material 80. Thereby, serves to restrict a production of bubbles that results inferiority in the transfer pattern formed on the substrate G. Here, a speed that the mold moving part 50 moves the mold supporting part 30 may be properly adjusted according to the kind and the property of the pattern forming material 80 within a range of not producing any bubble when the mold member 10 is immersing.

In addition, at least one of the mold supporting part 30 and the mold moving part 50 may shake the mold member 10 in the pattern forming material 80. In other words, at least one of the mold supporting part 30 and the mold moving part 50 may shake left and right or vibrate the mold member 10 in the pattern forming material 80. Accordingly, bubbles that may remain on the mold member 10 while immersed in the pattern forming material 80 can be removed.

A malfunction caused by the inflow of the pattern forming material 80 into the insides of the substrate supporting part 20 and the mold supporting part 30 is prevented by the substrate G and the mold member 10 adsorbed on the substrate supporting part 20 and the mold supporting part 30 by the vacuum adsorption method.

Also, the mold moving part 50 moves the mold supporting part 30 within a range of not or only partially immersing the mold supporting part 30 into the pattern forming material 80. Accordingly, waste or malfunction caused by the inflow of the pattern forming material 80 above the mold supporting part 30 can be prevented.

According to a configuration described above, the imprint apparatus 100 can prevent the production of bubbles. In other words, the formation of gas bubbles in the trapped air and the pattern forming material 80 while joining the mold member 10 with the substrate G can be prevented since the mold member 10 and the substrate G are joined while they are immersed in the liquid phase pattern forming material 80.

Accordingly, an inferior formation of the transfer pattern P on the substrate G is restricted and the deterioration of product quality can be prevented.

Also, an amount of the pattern forming material 80 can be reduced by decreasing the waste of the pattern forming material 80. Productivity can be also enhanced accordingly.

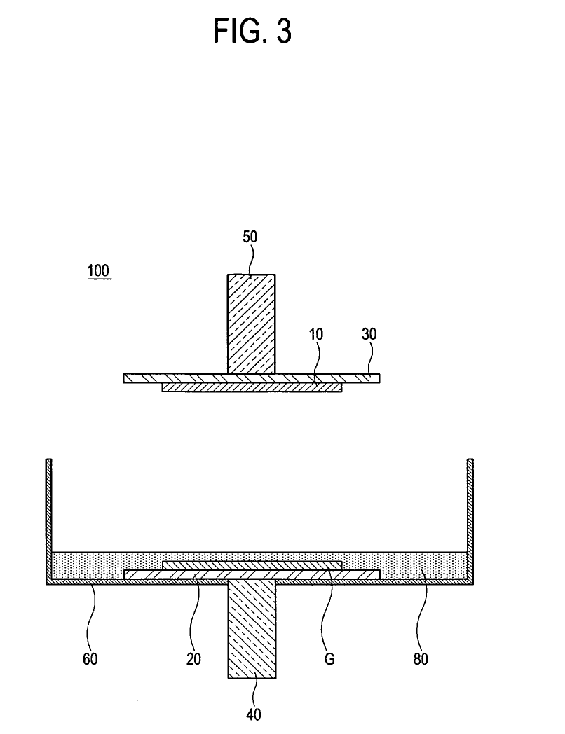

Hereinafter, an imprint method using the imprint apparatus according to the embodiment of the present invention will be described with reference to FIGS. 3 to 7 as well as FIGS. 1 and 2.

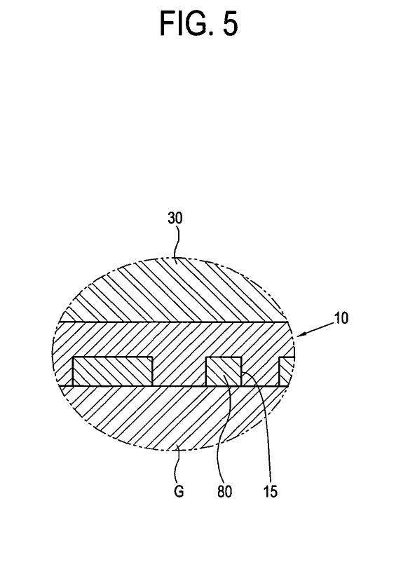

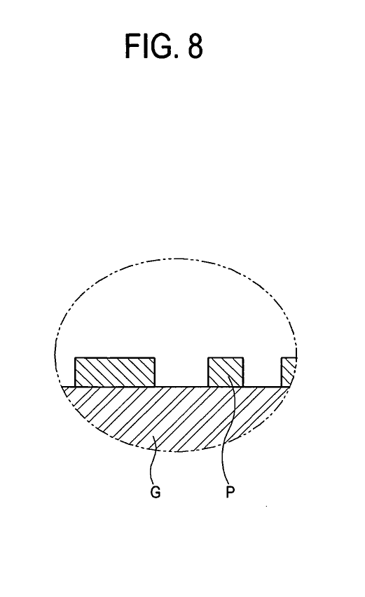

FIGS. 3, 4, 6, and 7 are schematic views illustrating an imprint method according to an exemplary embodiment of the present invention in a sequential order, FIG. 5 is an enlarged view of a portion of the contacted substrate and mold member in the pattern forming material according to an exemplary embodiment of the present invention, and FIG. 8 is an enlarged view a portion the substrate on which a transfer pattern is formed according to the present invention.

As shown in FIG. 1, the bath 60 is filled with the pattern forming material 80. The pattern forming material 80 is a liquid phase resin. Known resins in a variety of kinds may be used for the pattern forming material 80. Then, the substrate G and the mold member 10 are detachably mounted on the substrate supporting part 20 and the mold supporting part 30, respectively. At this time, the substrate supporting part 20 and the mold supporting part 30 may mount the substrate G and the mold member 10 by the vacuum adsorption method.

Next, as shown in FIG. 3, the substrate G is immersed into the pattern forming material 80. That is, the substrate moving part 40 moves the substrate supporting part 20 supporting the substrate G to immerse the substrate G into the pattern forming material 80. At this time, the substrate moving part 40 slowly moves the substrate supporting part 20 in order not to produce bubbles in the process of immersing the substrate G into the pattern forming material 80.

Also, at least one of the substrate support part 20 and the substrate moving part 40 shakes the substrate G in the pattern forming material 80. Thereby, the substrate G is shaken left and right or vibrated. Accordingly, air bubbles that remain on the surface of the substrate G immersed in the pattern forming material 80 are removed.

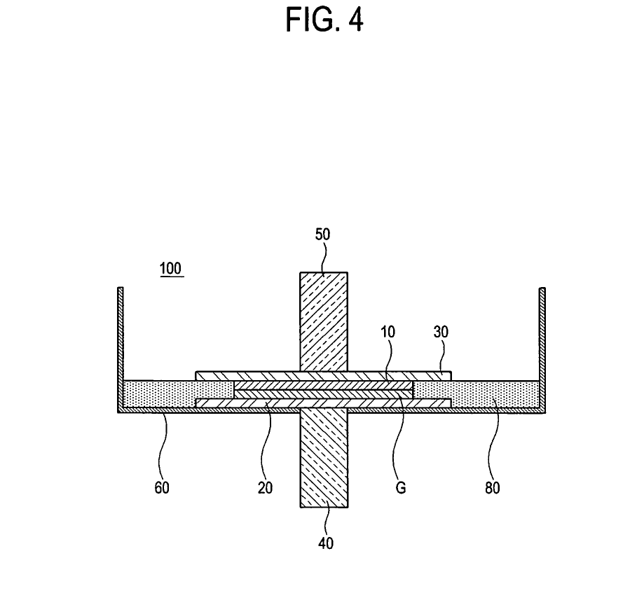

Next, as shown in FIG. 4, the mold member 10 is moved into contact with the substrate G in the pattern forming material 80. More particularly, the mold moving part 50 moves the mold supporting part 30 that supports the mold member 10 to move the mold member 10 into contact with substrate G in the pattern forming material 80. At this time, one side of the mold member 10 with the imprint pattern 15 contacts the substrate G. Also, the mold moving part 50 slowly moves the mold supporting part 30 in order to not produce the bubbles during the process of immersing the mold member 10 into the pattern forming material 80. Also, the mold moving part 50 moves the mold supporting part 30 within the range of not, or only partially, immersing the mold supporting part 30 into the pattern forming material 80. Also, the mold member 10 is shaken in the pattern forming material 80 before contacting substrate G by at least one of the mold supporting part 30 and the mold moving part 50. Thereby, the mold member 10 is shaken left and right or vibrated. Accordingly, any bubbles that remain on the surface of the mold member 10 in the pattern forming material 80 are removed.

A portion of the mold member 10 and substrate G that are contacted in the pattern forming material 80 is shown in FIG. 5. As shown in FIG. 5, the mold member 10 is in contact with the substrate G in the pattern forming material 80. Accordingly, the space between the imprint pattern 15 of the mold member 10 and the substrate G is filled with the pattern forming material 80.

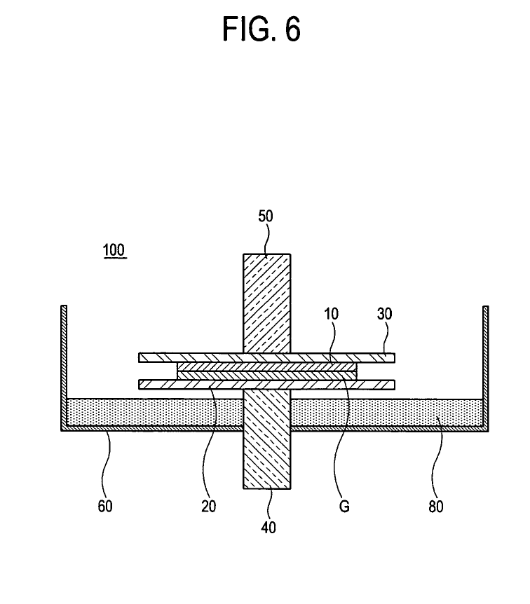

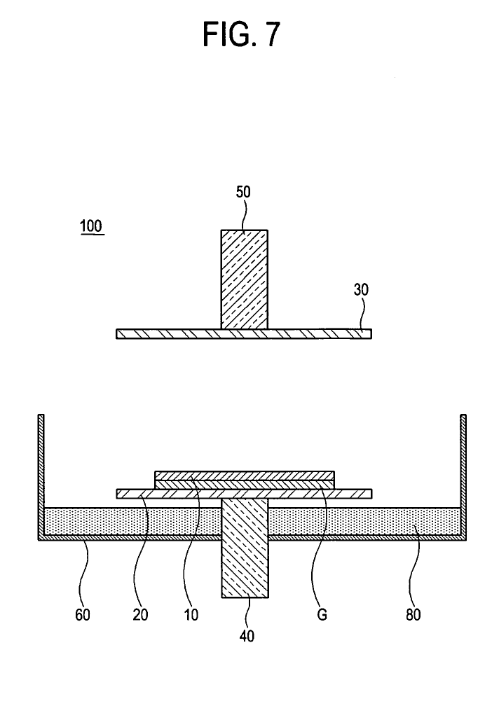

Next, as shown in FIG. 6, the substrate G while in contact with the mold member 10 is taken out from the phase pattern forming material 80, and then, as shown in FIG. 7, the mold member 10 and the mold supporting part 30 are separated from each other. However, the present invention is not limited to this. Alternatively, the substrate G while in contact with the mold member 10 may be taken out from the phase pattern forming material 80 after separating the mold member 10 and the mold supporting part 30 from each other.

Then, as shown in FIG. 8, the transfer pattern P is formed on the substrate 10 through irradiating light or heat-treating the substrate G while it is in contact with the mold member 10 to cure or solidify the pattern forming material 80 filled the space between the imprint pattern 15 of the mold member 10 and the substrate G. A method of curing or solidifying the pattern forming material 80 depends on the kind of pattern forming material 80. The thermoplastic resin, thermosetting resin and UV curable resin may be used for the pattern forming material 80

The substrate G formed with the transfer pattern P thereon is completed after separating the mold member 10 from the substrate G.

According to the manufacturing method of the present invention, the imprint method prevents the formation of bubbles. The bubbles from the gas produced in the trapped air and the pattern forming material while joining the mold member with the substrate is prevented through joining the mold member with the substrate G while they are immersed in the liquid phase pattern forming material.

Accordingly, an inferior formation of the transfer pattern on the substrate is restricted and the deterioration of product quality is prevented.

Also, an amount of the pattern forming material consumed in forming the transfer pattern is reduced by decreasing the waste of the pattern forming material. Productivity is also enhanced accordingly.

According to the present invention, the imprint apparatus prevents the producing of bubbles. In other words, the producing of bubbles by a gas produced from a trapped air and a pattern forming material when joining the mold member and the substrate under a state of immersing the mold member and the substrate in the pattern forming material.

Accordingly, a deterioration of product quality is prevented by restricting the forming of defective transfer pattern on the substrate.

Also, a waste of the pattern forming material is reduced and productivity is enhanced.

Also, the imprint method using the imprint apparatus is provided.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An imprint apparatus of forming a transfer pattern on a substrate, comprising:
a container comprising a pattern forming material; and
a mold member comprising an imprint pattern formed on a surface.

2. The apparatus of claim 1, wherein the pattern forming material comprises a liquid phase resin.

3. The apparatus of claim 2, wherein the substrate is immersed in the pattern forming material and the imprint pattern formed on the surface of the mold member is placed in contact with the substrate.

4. The apparatus of claim 3 further comprising:
a substrate supporting part supporting the substrate;
a mold supporting part supporting the mold member;
a substrate moving part moving the substrate supporting part to immerse the substrate into the pattern forming material; and
a mold moving part moving the mold supporting part to selectively move the mold member into contact with the substrate.

5. The apparatus of claim 4, wherein the substrate is detachably supported on the substrate supporting part by a vacuum adsorption method.

6. The apparatus of claim 4, wherein the mold member is detachably supported on the mold supporting part by a vacuum adsorption method.

7. The apparatus of claim 4, wherein the substrate moving part and the mold moving part respectively move the substrate supporting part and the mold supporting part in an upward and downward direction.

8. The apparatus of claim 4, wherein the mold moving part moves the mold supporting part within a range that the mold supporting part is partially immersed or not immersed into the pattern forming material.

9. The apparatus of claim 4, wherein at least one of the substrate supporting part and the substrate moving part shakes the substrate in the pattern forming material.

10. The apparatus of claim 4, wherein at least one of the mold supporting part and the mold moving part shakes the mold member immersed in the pattern forming material.

11. An imprint method of forming a transfer pattern on a substrate comprising:
providing a bath comprising a pattern forming material;
immersing the substrate in the pattern forming material; and
joining the substrate with a mold member comprising an imprint pattern in the pattern forming material.

12. The method of claim 11, wherein the pattern forming material comprises a liquid phase resin.

13. The method of claim 11, wherein the substrate is detachably supported by a substrate supporting part and the substrate supporting part is moved by a substrate moving part to immerse the substrate in the pattern forming material.

14. The method of claim 11, wherein the mold member is detachably supported by a mold supporting part and the mold supporting part is moved by a mold moving part to join the mold member and the substrate in the pattern forming material.

15. The method of claim 14, wherein the mold supporting part is not immersed or partially immersed in the pattern forming material.

16. The method of claim 11, further comprising taking out the substrate joined with the mold member from the pattern forming material.

17. The method according to claim 11, further comprising shaking at least one of the substrate and the mold member before the joining of the substrate with the mold member.
